(19) United States
(12) Patent Application Publication
(10) Pub. No.: US 2010/0053448 A1
(43) Pub. Date: Mar. 4, 2010

(54) SYSTEMS AND METHODS FOR PICTURE ENHANCEMENT

(76) Inventor: Masafumi D. Naka, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/550,598

(22) Filed: Aug. 31, 2009

Related U.S. Application Data
(60) Provisional application No. 61/093,377, filed on Sep. 1, 2008.

(51) Int. Cl. H04N 5/21

(52) U.S. Cl. 348/630; 348/E05.077

(57) ABSTRACT

Systems and methods for effectively and naturally enhancing the appearance of human faces in television pictures carried by a program signal. The appearance of the detected face is enhanced by adjusting the color hue to a natural looking color and sharpening the edges of the eyes.

### CROSS-REFERENCE TO RELATED APPLICATION

This application claims the benefit of provisional application Ser. No. 61/093,377 filed Sep. 1, 2008, which is fully incorporated herein by reference.

### FIELD

The present invention relates generally to televisions and, more particularly, to systems and methods that facilitate optimization of the picture in the human face region of the picture.

### BACKGROUND

Images displayed on a television screen are subject to variations in color and quality due to improper television picture settings and/or less than ideal or inconsistent production, signal processing and transmission conditions. Many attempts have been made to improve or enhance image or picture quality. Conventional enhancement technology typically applies the enhance to the entire image. Such global application of the enhancement tends to have its drawbacks. For example, with regard to correcting the skin color of a human's face, other objects color which are similar to the human face also get corrected. Also, when watching a human face in a video image on the television, most of viewers tend to look at the eyes. In general, shaper eyes provide a better image. However, as with skin color, conventional solutions tend to sharpen the entire image and not just the eyes. As a result, the image is over enhanced, or becomes noisy.

In conventional systems, if noise sharpness or reduction is applied to an entire image or picture, a human face will also get enhanced. As the result, skin becomes noisy, or will cause “tailing effect” on human face. Therefore, it would be desirable to provide systems and methods that facilitate image enhancement without the drawbacks noted above.

### SUMMARY

Embodiments described herein are directed to improved methods and systems for effectively enhancing the image through global noise reduction of the surrounding image in television pictures without effecting detected human faces within the image. The enhanced picture includes color correction and eye sharpness. In one embodiment, a television system adapted to enhance the image preferably comprises a central processing unit (CPU) coupled to an audio-video output unit. The CPU preferably comprises non-volatile memory coupled to a logic unit which is adapted to receive and process a program signal S_{P} and output an enhanced program signal S_{EP} to the audio-video output unit. The logic unit preferably includes a human face detection circuit, a human eye detection circuit and a picture enhancement circuit adapted to correct color or reduce noise in the image surrounding human faces without effecting the human faces and sharpen the edges of the eyes.

In operation, the program signal S_{P} is passed through the human face and human eye detection circuits to detect the presence of a human face in the image and the eyes in a detected face. The program signal Sp is then passed through the picture enhancement circuit to correct the color or reduce noise in the image surrounding the detected face or faces without effecting the detected face or faces and enhance the sharpness of the eyes in the detected face or faces.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic diagram of a television system.

FIG. 2 is a schematic diagram of an embodiment of the logic unit of the television system shown in FIG. 1.

FIG. 3 is a process diagram depicting a method for enhancement of the human face and eyes of the human face in a television picture.

FIG. 4 is a schematic diagram of the embodiment of the logic unit of the television system shown in FIG. 2 with corresponding processed signal images.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

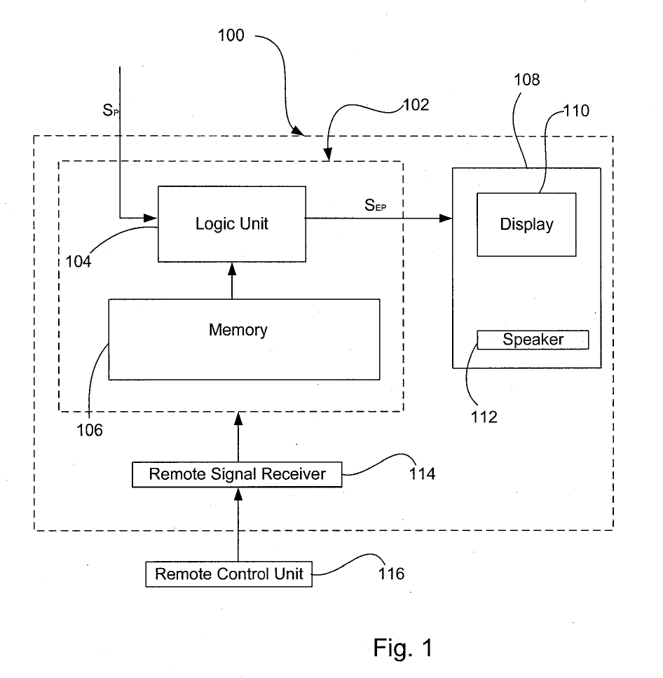

Embodiments described herein are directed to improved methods and systems for effectively and naturally enhancing the human face and eyes in television pictures. Turning to FIGS. 1-4, the embodiments provided herein are described in detail. In one embodiment, as depicted in FIG. 1, a television system 100 adapted to enhance the relative contrast between image objects and backgrounds images of a television picture through color correction or noise reduction and edge enhancement preferably comprises a central processing unit (CPU) 102 coupled to an audio-video output unit 108 and a remote signal receiver 114, which is operably coupled to a remote control unit 116. The CPU 102 preferably comprises non-volatile memory 106 coupled to a logic unit 104 which is adapted to receive and process a program signal S_{P} and output an enhanced program signal S_{EP} to the audio-video output unit 108. The audio-video output unit 108 preferably includes a video display 110 for displaying the television picture or video component of the enhanced program signal S_{EP} and a speaker 112 for outputting the audio component of the enhanced program signal S_{EP} associated with the video component of enhanced program signal S_{EP}.

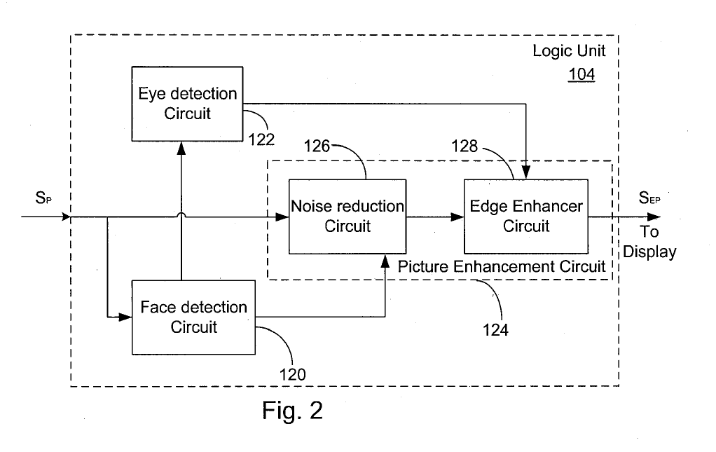

As depicted in FIG. 2, the logic unit 104 preferably includes a real time human face detection circuit 120 adapted to detect the human faces within the television picture, an human eye detection circuit 122 coupled to human face detection circuit 120 and adapted to detect the eyes of the detected human faces within the television picture, and a picture enhancement circuit 124 coupled to the human face and eye detection circuits 120 and 122 and adapted to correct the color or reduce noise in the image surrounding the detected human face or faces and sharpen the eyes of the detected face without effecting other portions of the image. Human face and eye detection systems and circuits are known within the art and commonly used in digital cameras and the like to determine the focal point to the object and in photo editors for red eye correction. See, e.g., U.S. Pat. Nos. 7,574,128, 7,526,193 and 7,577,354, and Japanese Patent Applications 9-101579, 2003-197404, 2003-318701 and 2005-373901, which are incorporated herein by reference.

The picture enhancement circuit 124 preferably comprises a color phase correction or noise reduction circuit 126 and an eye edge enhancement circuit 128 coupled to the color phase correction circuit 126, both of which are readily known and commonly used within the art. The color phase correction or noise reduction circuit 126 corrects or adjusts the color of the image surrounding the detected human face or faces without effecting the detected human face or faces. The eye edge enhancement circuit 128 enhances the edge of the eyes in the detected face to sharpen their appearance. The optimized noise reduction, however, is preferably only applied to the image surrounding the detected human face or faces in the image.

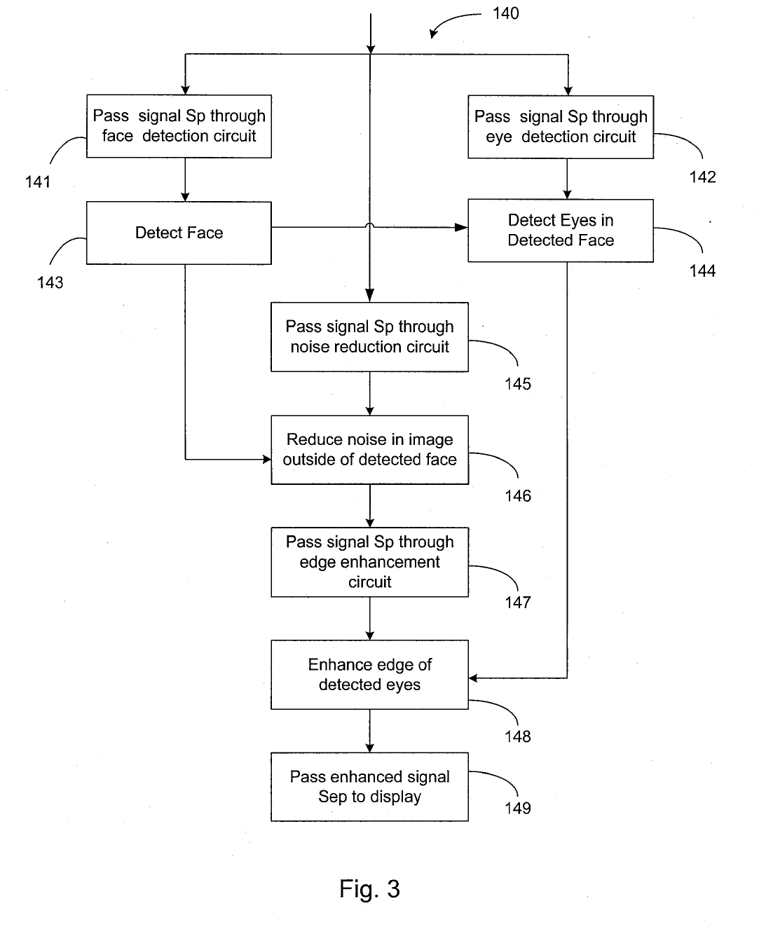

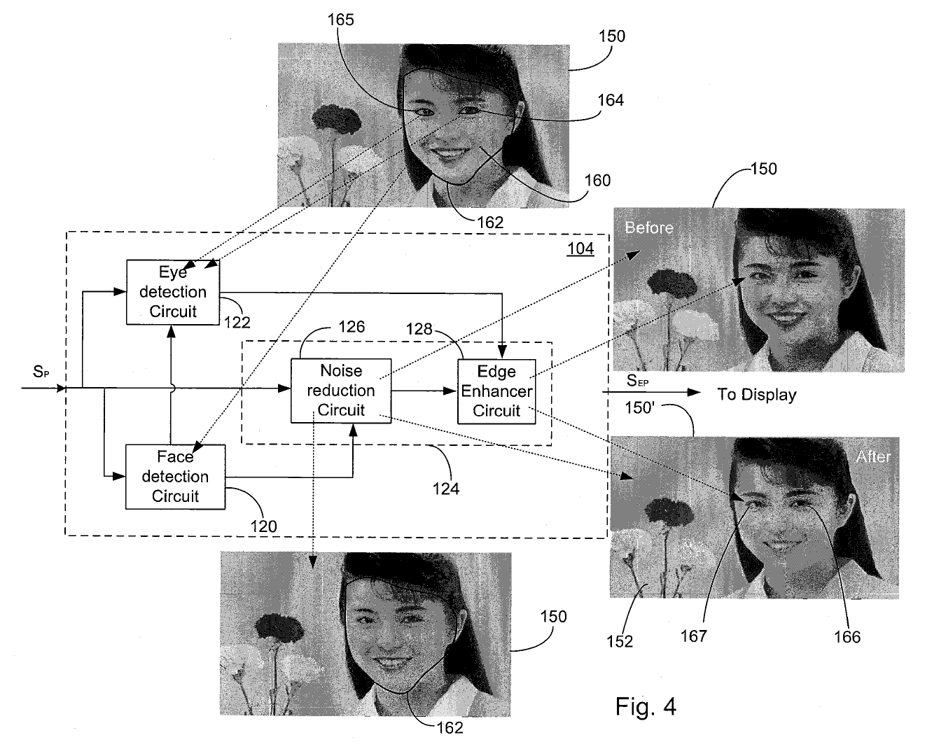

In operation, a process 140 depicted in FIG. 3 is used to generate an enhance program signal S_{EP}. Turning to FIGS. 3 and 4, the program signal S_{P} is passed through the human face detection circuit 120 at step 141 to detect the presence of a human face or faces in the image carried by the program signal S_{P} and the human face 162 or faces in the image 150 are detected at step 143. The program signal S_{P} is passed through the eye detection circuit 122 at step 142 to detect the eyes in a detected face or faces and, while using the detected face 162 information received from the face detection circuit 120, the eye detection circuit 122 at step 144 detects eyes 164 and 165 in the detected face 162 at step 144. The program signal Sp is then passed at step 145 through the color phase correction circuit 126 which uses the detected face 162 information from the detected face circuit 120 to correct the color or reduce noise at step 146 in the image 152 surrounding the detected face 162. At step 147, the program signal Sp is passed through the eye edge enhancement circuit 128 of the picture enhancement circuit 124, which, at step 148, using the detected eye information received from the eye detection circuit 122, enhances the sharpness of the eyes in the detected face or faces by enhancing the edges 166 and 167 of the eyes. The enhanced program signal S_{EP} carrying the enhanced image 150′ is then passed on to the display at step 149.

The particular examples set forth herein are instructional and should not be interpreted as limitations on the applications to which those of ordinary skill are able to apply the systems and methods described herein. Modifications and other uses are available to those skilled in the art which are encompassed within the spirit of the invention as defined by the scope of the appended claims.

What is claimed is:

1. A television system adapted to enhance human faces appearing in the images carried by a program signal comprising
an audio-video output unit, and
a central processing unit (CPU) coupled to the audio-video output unit, the CPU comprising,
non-volatile memory, and
a logic unit coupled which is configured to receive and enhance a program signal by correcting color of an image without effecting a detected face within the image and enhancing eye edge sharpness.

2. The television system of claim 1 wherein the login unit comprises
an human face detection circuit adapted to detect the presence of a human face in the image carried by the program signal,
an eye detection circuit coupled to the human face detection circuit and adapted to detect the eyes of the detected human face in the image, and
a picture enhancement circuit coupled to the face and eye detection circuits.

3. The television system of claim 2 wherein the picture enhancement circuit comprises
a color phase correction circuit coupled to the face detection circuit, and
an eye edge enhancement circuit coupled to the color phase correction circuit and the eye detection circuit.

4. A method for enhancing the appearance of human faces appearing in images carried by a program signal comprising the steps of
receiving a program signal,
detecting a human face in a television picture in the program signal, and
adjusting the color of the television picture without effecting the detected face within the television picture.

5. The method of claim 4 further comprising the steps of wherein the steps of detecting the eyes in the detected human face in the television picture, and enhancing the edge of the eyes to sharpen the appearance of the eyes.
